(19) United States
(12) Patent Application Publication
(10) Pub. No.: US 2023/0307771 A1
(43) Pub. Date: Sep. 28, 2023

(54) TRACTION BATTERY PACK ELECTRONICS SUPPORT PLATE AND ELECTRONICS SUPPORT METHOD

(71) Applicant: Ford Global Technologies, LLC, Dearborn, MI (US)

(72) Inventors: Che-chun Chang, Ann Arbor, MI (US); Patrick Daniel Maguire, Ann Arbor, MI (US); Mohammadreza Eftekhari, Novi, MI (US); Jason C. Marcath, Dearborn, MI (US); Karen Siler, Commerce Twp., MI (US)

(21) Appl. No.: 17/844,273

(22) Filed: Jun. 20, 2022

Related U.S. Application Data
(60) Provisional application No. 63/322,766, filed on Mar. 23, 2022.

(51) Int. Cl. H01M 50/287; B60L 50/60; B60K 1/04; H01M 50/209; H01M 50/271; H01M 50/262

(52) U.S. Cl. CPC H01M 50/287; B60L 50/66; B60K 1/04; H01M 50/209; H01M 50/271; H01M 50/262; B60K 2001/0438; H01M 2220/20

(57) ABSTRACT

A traction battery pack assembly includes battery cells, an enclosure tray, an enclosure cover that is secured to enclosure tray to provide an interior area that houses the plurality of battery cells, and an electronics support plate supported by the enclosure cover. A traction battery electronics support method includes positioning battery cells of a traction battery pack within an enclosure tray of the traction battery pack, connecting at least one electronics module electrically to other components of the traction battery pack. After the connecting, the method includes securing an electronics support plate to an enclosure cover of the traction battery pack. The electronics support plate supports the at least one electronics module.

### CROSS-REFERENCE TO RELATED APPLICATIONS

This application claims priority to U.S. Provisional Application No. 63/322,766, which was filed on 23 Mar. 2022 and is incorporated herein by reference.

### TECHNICAL FIELD

This disclosure relates generally to a traction battery pack assembly and, more particularly, to securing one or more electronics modules of the traction battery pack assembly.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells arranged in one or more battery arrays.

### SUMMARY

In some aspects, the techniques described herein relate to a traction battery pack assembly, including: a plurality of battery cells; an enclosure tray; an enclosure cover that is secured to enclosure tray to provide an interior area that houses the plurality of battery cells; and an electronics support plate supported by the enclosure cover.

In some aspects, the techniques described herein relate to a traction battery pack assembly, further including at least one electronics module supported on the electronics support plate.

In some aspects, the techniques described herein relate to a traction battery pack assembly, wherein the at least one electronics module includes a Battery Energy Control Module.

In some aspects, the techniques described herein relate to a traction battery pack assembly, wherein the electronics support plate is suspended from the enclosure cover.

In some aspects, the techniques described herein relate to a traction battery pack assembly, further including a plurality of mechanical fasteners that secure the electronics support plate relative to the enclosure cover.

In some aspects, the techniques described herein relate to a traction battery pack assembly, further including a plurality of brackets secured directly to the enclosure cover, the plurality of mechanical fasteners engaging respective ones of the plurality of brackets to secure the electronics support plate relative to the enclosure cover.

In some aspects, the techniques described herein relate to a traction battery pack assembly, wherein the plurality of brackets are secured to a horizontally facing surface of the enclosure cover.

In some aspects, the techniques described herein relate to a traction battery pack assembly, wherein the enclosure cover is secured directly to the enclosure tray at an interface that extends circumferentially continuously about the interior area.

In some aspects, the techniques described herein relate to a traction battery pack assembly, wherein the electronics support plate is vertically above the plurality of battery cells.

In some aspects, the techniques described herein relate to a traction battery pack assembly, wherein the electronics support plate is spaced a distance from the plurality of battery cells.

In some aspects, the techniques described herein relate to a traction battery pack assembly, further including an access panel configured to block an access opening that provides access to a plurality of fasteners that secure the electronic support plate to the enclosure cover.

In some aspects, the techniques described herein relate to a traction battery pack assembly, wherein the enclosure tray includes a plurality of side walls, the plurality of battery cells compressed by the side walls.

In some aspects, the techniques described herein relate to a traction battery electronics support method, including positioning a plurality of battery cells of a traction battery pack within an enclosure tray of the traction battery pack; connecting at least one electronics module electrically to other components of the traction battery pack; and after the connecting, securing an electronics support plate to an enclosure cover of the traction battery pack, the electronics support plate supporting the at least one electronics module.

In some aspects, the techniques described herein relate to a traction battery electronics support method, further including, after the connecting and prior to securing the electronics support plate to the enclosure cover, securing the enclosure cover directly to the enclosure tray.

In some aspects, the techniques described herein relate to a traction battery electronics support method, wherein the enclosure cover is secured to the enclosure tray to provide an interior area, the enclosure cover secured directly to the enclosure tray at an interface that extends circumferentially continuously about the interior area.

In some aspects, the techniques described herein relate to a traction battery electronics support method, further including securing the electronics support plate to the enclosure cover using a plurality of brackets and a plurality of mechanical fasteners, the plurality of mechanical fasteners accessed through an access opening in the enclosure cover during the securing.

In some aspects, the techniques described herein relate to a traction battery electronics support method, further including, after the securing, closing the access opening with an access panel.

In some aspects, the techniques described herein relate to a traction battery electronics support method, wherein, after the securing, the electronics support plate is suspended from the enclosure cover.

In some aspects, the techniques described herein relate to a traction battery electronics support method, wherein the electronics support plate is secured at a position vertically above, and spaced a distance from, the plurality of battery cells.

In some aspects, the techniques described herein relate to a traction battery electronics support method, wherein the enclosure tray includes a plurality of side walls, the plurality of battery cells compressed by the side walls.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack assembly.

FIG. 2 illustrates an expanded view of the traction battery pack assembly of FIG. 1 according to an exemplary aspect of the present disclosure.

FIG. 3 illustrates a cell matrix and enclosure tray from the traction battery pack assembly of FIG. 2.

FIG. 4 illustrates a cell stack from the cell matrix of FIG. 3.

FIG. 5 illustrates a side view of a portion of the traction battery pack assembly when assembled.

FIG. 6 illustrates a section view of the portion of the traction battery pack assembly shown in FIG. 5.

### DETAILED DESCRIPTION

This disclosure details example traction battery pack assemblies having an enclosure that provides an interior area. Battery cells and electronic modules can be held within the interior area along with other components. The battery cells can be used to power an electric machine.

In particular, this disclosure details an exemplary systems and methods relating to retaining electronics modules within the interior of an enclosure. In an example, the electronics module can be secured in a position where the electronics module is suspended from part of the enclosure.

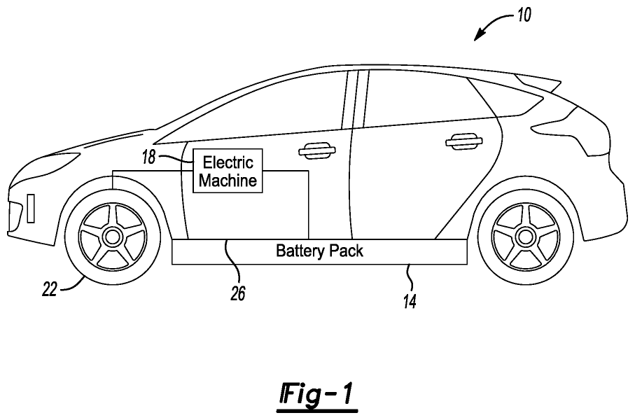

With reference to FIG. 1, an electrified vehicle 10 includes a traction battery pack assembly 14, an electric machine 18, and wheels 22. The traction battery pack assembly 14 powers an electric machine 18, which can convert electrical power to torque to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

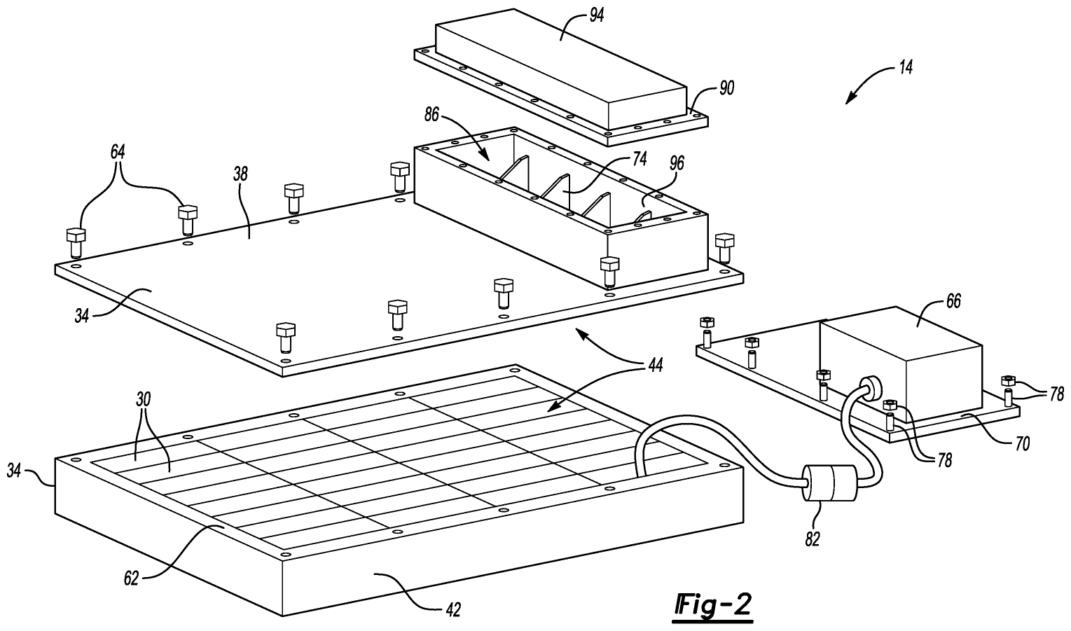

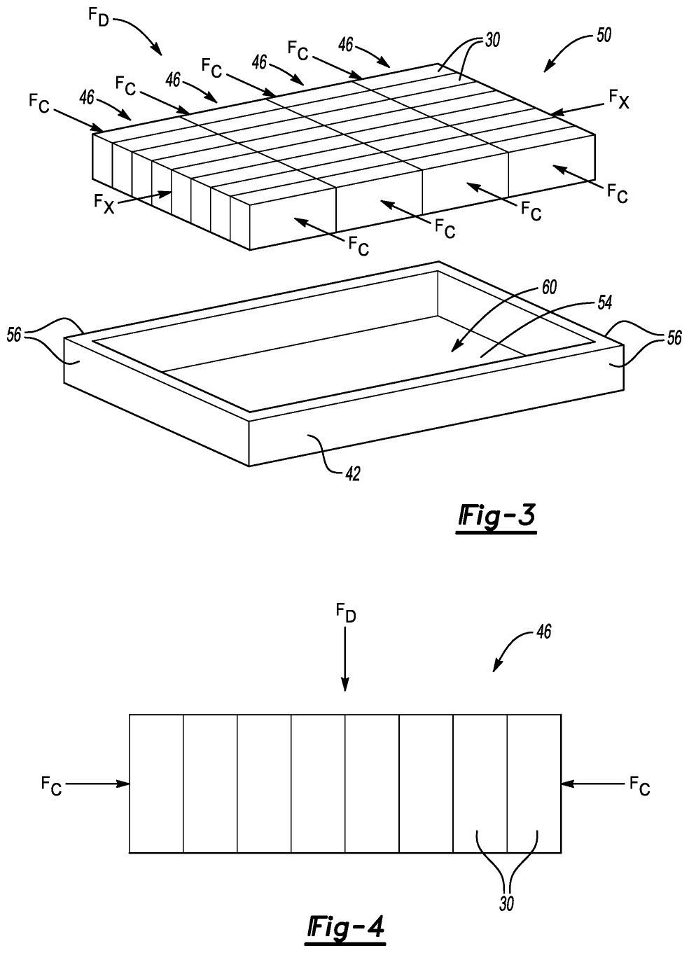

With reference now to FIGS. 2 and 3, the traction battery pack assembly 14 includes a plurality of battery cells 30 held within an enclosure assembly 34. In the exemplary embodiment, the enclosure assembly 34 includes an enclosure cover 38 and an enclosure tray 42. The enclosure cover 38 is secured to the enclosure tray 42 to provide an interior area 44 that houses the plurality of battery cells 30.

The plurality of battery cells (or simply, “cells”) 30 are for supplying electrical power to various components of the electrified vehicle 10. The battery cells 30 are stacked side-by-side relative to one another to construct a cell stack 46, which are positioned side-by-side to provide a cell matrix 50. In this example, each cell stack 46 includes eight individual battery cells 30, and the cell matrix 50 includes four cell stacks 46.

Although a specific number of battery cells 30 and cells stacks 46 are illustrated in the various figures of this disclosure, the traction battery pack assembly 14 could include any number of cells 30 and cell stacks 46. In other words, this disclosure is not limited to the specific configuration of cells 30 shown in FIGS. 2 and 3.

In an embodiment, the battery cells 30 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure tray 42, in this example, includes a floor 54 and a plurality of side walls 56 arranged relative to one another to provide a cell-compressing opening 60. The floor 54 and side walls 56 can be connected together by welding, or may be stamped from one piece of sheet metal, for example.

When the traction battery pack assembly 14 is assembled, the enclosure cover 38 can be secured to the enclosure tray 42 at an interface 62 that extends circumferentially continuously about the interior area 44. Mechanical fasteners 64 can be used to secure the enclosure cover 38 to the enclosure tray 42.

When the traction battery pack assembly 14 is assembled, the cell matrix 50 is positioned within the cell-compressing opening 60. The example enclosure tray 42 includes one cell-compressing opening 60, but it should be understood that this disclosure extends to structural assemblies providing one or more cell-compressing openings. The enclosure cover 38 can cover the cell matrix 50 within the cell-compressing opening 60 to substantially surround the cells 30 from all sides.

The enclosure tray 42 compresses and holds the cell matrix 50 when the cell matrix 50 is received within the cell-compressing opening 60. In this example, the side walls 56 apply forces to the cell matrix 50 when the cell matrix 50 is positioned within the cell-compressing opening 60.

In this disclosure, in order to insert the cell matrix 50 into the cell-compressing opening 60, the cell matrix 50 is first compressed, and, while compressed, moved into place in the cell-compressing opening 60.

FIG. 4 schematically illustrates a compressive force F_{C} applied to opposed ends of one of the cell stacks 46. The compressive force F_{C} essentially squeezes battery cells 30 within the cell stack 46, thereby compressing the cell stack 46 and the individual battery cells 30 to a reduced thickness. While the compressive force F_{C} is applied, the cell stack 46 is inserted into a respective cell-compressing opening 60 by a downward force FD, which is also schematically illustrated in FIG. 4.

In this example, the downward force FD is applied directly to one or more of the battery cells 30. In another example, the downward force FD could be applied at least one support plate, which are, for example, arranged at opposite ends of the cell stack 46. Such plates are not battery cells, but are rather structures formed as plates and made of a plastic or a metallic material, as examples.

While the term “downward” is used herein to describe the downward force FD, it should be understood that the term “downward” is used herein to refer to all forces tending to press a cell stack 46 into a cell compressing opening. In particular, the term “downward” refers to all forces substantially perpendicular to the compressive force F_{C}, whether or not the force is truly in a “downward” direction. For example, this disclosure extends to cell stacks that are compressed and inserted into a cell-compressing in a sideways direction.

The cell stacks 46 could be individually compressed and inserted into the cell-compressing opening 60. In another example, the entire cell matrix 50 is compressed and inserted into the cell-compressing opening 60. As shown in FIG. 3, in such an example, other compressive forces F_{X} can compress the cell stacks 46 together for insertion into the cell-compressing opening. F_{X} may be a distributed load across multiple cells, or on to one or more support plates. The forces F_{X} are perpendicular to the forces F_{C}. The force F_{X} are applied together with the forces F_{C}. The force FD is then applied to move the entire cell matrix 50 into the cell-compressing opening 60.

In this example, an entire perimeter of the cell-compressing opening 60 is defined by the side walls 56 of the enclosure tray 42. The side walls 56 can apply a compressive force to the battery cells about the entire perimeter of the battery cells 30. The side walls 56 act as a rigid halo-type structure that compresses and tightly holds the cell matrix 50 30.

This configuration in the exemplary embodiment can be considered a Cell-To-Pack (CTP) battery pack, which differs from known battery pack types that have enclosures holding arrays of battery cells compressed between plates that are spaced away from walls of an enclosure, and where the enclosure does not compress any battery cells.

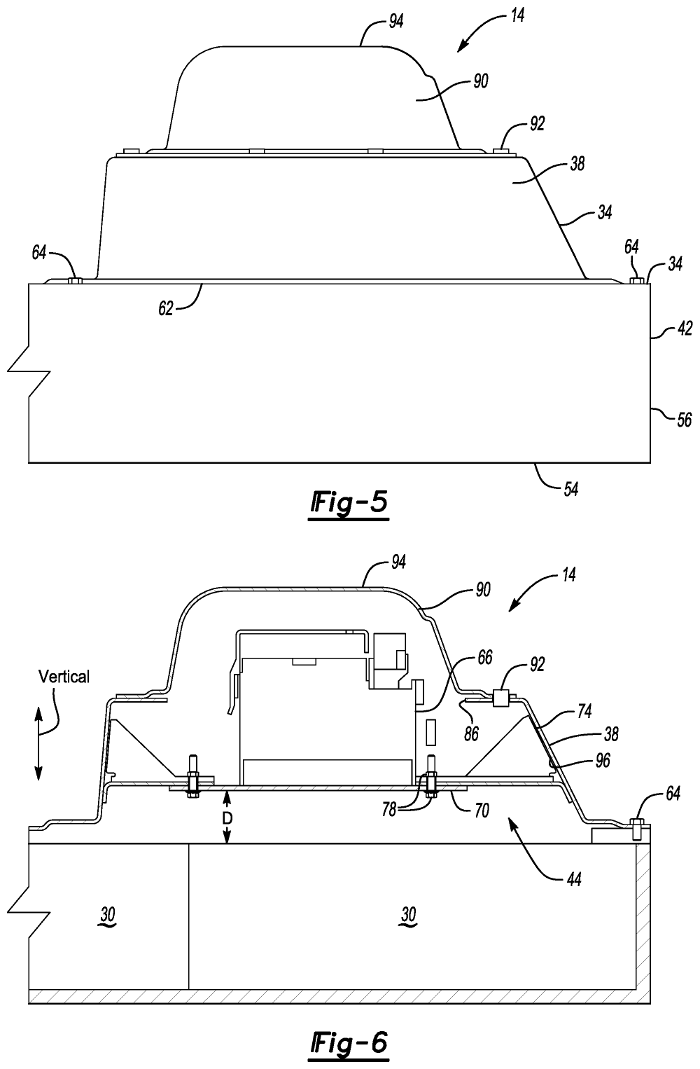

Referring now to FIGS. 5 and 6 with continuing reference to FIGS. 2-4, in addition to housing the battery cells 30, the interior area 44 of the enclosure assembly 34 houses various electronics and electronics modules. An example electronics module 66 housed within the interior area 44 is a Battery Energy Control Module (BECM) for battery system control and internal and external communication. Another example electronics module 66 could by a Bussed Electrical Center (BEC) for contactor control, fuse support, and current measurement.

In the example embodiment, an electronics support plate 70 is used to support the electronics module 66 within the interior area 44. The electronics support plate 70 is, notably, supported by the enclosure cover 38. In particular, the example electronics support plate 70 is suspended from the enclosure cover 38 via a plurality of brackets 74 and a plurality of mechanical fasteners 78, such as threaded fasteners.

Within the interior area 44, the electronics support plate 70 is supported by the enclosure cover 38 at a position where the electronics support plate 70 is vertically above, and spaced a distance D from, the cell matrix 50. The electronics module 66 is thus supported at a position vertically above, and spaced a distance from, the cell matrix 50.

The electronics module 66 is electrically connected to other components of the traction battery pack assembly 14 via a one or more electrical connections 82. Notably, in the example embodiment, at least some of the electrical connections 82 are established prior to securing the electronics support plate 70 to the enclosure cover 38. The enclosure cover 38 can also be secured to the enclosure tray 42 prior to securing the electronics support plate 70 to the enclosure cover 38. The electronics module 66 can be be secured to the electronics support plate 70 and placed onto the cells 30 with the inclusion of a separation from the energized portions of the cells 30 and the support plate 70, or alternatively the inclusion of an insulative material on the bottom of support plate 70. After at least some of the electrical connections 82 are secured, the cover 34 may be placed over the support plate 70 and electronics module 66.

The enclosure cover 38, in this example, includes an access opening 86. An operator can reach through the access opening 86 to secure the plurality of mechanical fasteners 78 when the enclosure cover 38 is secured to the enclosure tray 42.

When access to the mechanical fasteners 78 is no longer needed, an access panel 90 can be used to block the access opening 86. Mechanical fasteners 92 can be used to secure the access panel 90 to the enclosure cover 38. The access panel 90 interfaces with the enclosure cover 38 along an interface that is disposed along a horizontal plane. In another example, the interface is angled relative to horizontal such that the interface, and the access panel 90, are sloped.

An example method of assembling the traction battery pack assembly 14 can thus generally include positioning the cell matrix 50 within an enclosure tray 42. Next, an electronics module 66 and electronics support plate 70 can be positioned near the cell matrix 50 so that the electronics module 66 can be electrically connected to other components of the traction battery pack assembly 14. During the connecting, the electronics support plate 70 could rest directly on the cell matrix 50.

After electrical connecting the electronics module 66, the enclosure cover 38 can be secured to the enclosure tray 42. An operator can then, when the enclosure cover 38 is secured to the enclosure tray 42, reach a torque tool through the access opening 86 in the enclosure cover 38, use a torque tool to rotate the mechanical fasteners 78 to secure the electronics support plate 70 to the brackets 74 and thus to the enclosure cover 38.

The enclosure cover 38, in this example, includes a bumped-out area 94 or hump. As the mechanical fasteners 78 are secured, the electronics support plate 70 and the electronics module 66 are drawn upward into the bumped-out area 94. This elevates the support plate 70 off of the cells 30 and up to the cover 34, which develops the separation distance D. In this example, the brackets 74 are secured to horizontally facing surfaces 96 of the enclosure cover 38. This positioning may help to provide clearance for the operator to secure the mechanical fasteners 78.

After the mechanical fasteners 78 are engaged with the brackets 74, the operator can close the access opening 86 by fastening the access panel 90 to the enclosure cover 38 using the mechanical fasteners 92.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a plurality of battery cells;
an enclosure tray;
an enclosure cover that is secured to enclosure tray to provide an interior area that houses the plurality of battery cells; and
an electronics support plate supported by the enclosure cover.

2. The traction battery pack assembly of claim 1, further comprising at least one electronics module supported on the electronics support plate.

3. The traction battery pack assembly of claim 2, wherein the at least one electronics module comprises a Battery Energy Control Module.

4. The traction battery pack assembly of claim 1, wherein the electronics support plate is suspended from the enclosure cover.

5. The traction battery pack assembly of claim 1, further comprising a plurality of mechanical fasteners that secure the electronics support plate relative to the enclosure cover.

6. The traction battery pack assembly of claim 5, further comprising a plurality of brackets secured directly to the enclosure cover, the plurality of mechanical fasteners engaging respective ones of the plurality of brackets to secure the electronics support plate relative to the enclosure cover.

7. The traction battery pack assembly of claim 6, wherein the plurality of brackets are secured to a horizontally facing surface of the enclosure cover.

8. The traction battery pack assembly of claim 1, wherein the enclosure cover is secured directly to the enclosure tray at an interface that extends circumferentially continuously about the interior area.

9. The traction battery pack assembly of claim 1, wherein the electronics support plate is vertically above the plurality of battery cells.

10. The traction battery pack assembly of claim 9, wherein the electronics support plate is spaced a distance from the plurality of battery cells.

11. The traction battery pack assembly of claim 1, further comprising an access panel configured to block an access opening that provides access to a plurality of fasteners that secure the electronic support plate to the enclosure cover.

12. The traction battery pack assembly of claim 1, wherein the enclosure tray comprises a plurality of side walls, the plurality of battery cells compressed by the side walls.

13. A traction battery electronics support method, comprising:
positioning a plurality of battery cells of a traction battery pack within an enclosure tray of the traction battery pack;
connecting at least one electronics module electrically to other components of the traction battery pack; and
after the connecting, securing an electronics support plate to an enclosure cover of the traction battery pack, the electronics support plate supporting the at least one electronics module.

14. The traction battery electronics support method of claim 13, further comprising, after the connecting and prior to securing the electronics support plate to the enclosure cover, securing the enclosure cover directly to the enclosure tray.

15. The traction battery electronics support method of claim 14, wherein the enclosure cover is secured to the enclosure tray to provide an interior area, the enclosure cover secured directly to the enclosure tray at an interface that extends circumferentially continuously about the interior area.

16. The traction battery electronics support method of claim 13, further comprising securing the electronics support plate to the enclosure cover using a plurality of brackets and a plurality of mechanical fasteners, the plurality of mechanical fasteners accessed through an access opening in the enclosure cover during the securing.

17. The traction battery electronics support method of claim 16, further comprising, after the securing, closing the access opening with an access panel.

18. The traction battery electronics support method of claim 13, wherein, after the securing, the electronics support plate is suspended from the enclosure cover.

19. The traction battery electronics support method of claim 13, wherein the electronics support plate is secured at a position vertically above, and spaced a distance from, the plurality of battery cells.

20. The traction battery electronics support method of claim 13, wherein the enclosure tray comprises a plurality of side walls, the plurality of battery cells compressed by the side walls.
